(19) United States
(12) Patent Application Publication
(10) Pub. No.: US 2020/0306008 A1
(43) Pub. Date: Oct. 1, 2020

(54) ENDODONTICS SURGICAL STENT

(71) Applicant: CORNERSTONE SPECIALTY PRODUCTS, LLC, Irvine, CA (US)

(72) Inventors: Hamid Reza ABEDI, Irvine, CA (US); Mohammadreza FOROUGHI, Irvine, CA (US); Nick Nima KHALILI, Anaheim, CA (US)

(21) Appl. No.: 16/365,468

(22) Filed: Mar. 26, 2019

(51) Int. Cl. A61C 1/08; A61C 8/00

(52) U.S. Cl. CPC A61C 1/084; A61C 3/04; A61C 8/0089

(57) ABSTRACT

Dental surgical stents can be used to assist a dental surgeon. A hard tissue stent can include an access hole formed in one side and may be placed over one or more of the patient's teeth where the access hole is accurately aligned at a location for drilling to, for example, remove infection. A soft tissue stent may be placed over one or more of the patient's teeth, where the stent can include a mark positioned where the surgeon is to cut to create an access flap in the soft tissue. By keeping the flap attached to the semi-circular window of the soft tissue stent, the surgeon can more easily return the flap to the proper position.

### BACKGROUND OF THE INVENTION

### 1. Field of the Invention

Embodiments of the invention relates generally to dental instruments. More particularly, the invention relates to dental surgical stents that fit a patient's tooth or teeth to help guide a dentist during a procedure such as a root canal, apicoectomy, or the like.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The primary aim of any endodontic treatment is to disinfect the root canal system in order to reduce the bacterial load as much as possible and to seal the system to prevent ingress or egress of bacteria or their byproducts. A root canal procedure often accesses the root from the top of the tooth to remove infection therein. In some applications, a dental professional, such as an endodontist, would need to access infection of the root from the bottom of the tooth. A flap may be made of the soft tissue to provide access to the bone and a tool may be used to remove the bone to gain access to the area containing the infection, such as a root tip. The infection may be removed, and the flap replaced to heal. In some circumstances, the root tip may be removed, and the root canal treated and sealed.

Often, once a flap is cut, it is difficult to handle and maintain in its proper position during the surgical procedure. The surgeon needs to keep the flap out of the way during the surgery and properly position the flap back in place thereafter. The soft tissue flap may be difficult to handle after it is cut.

Moreover, to access the infection, the surgeon may need to remove a substantial amount of bone to not only gain access but also to visually ensure the position and depth of hard tissue is correct.

In view of the foregoing, there is a need for dental surgical stents that may secure the flap during surgery as well as provide a hard tissue drilling location during dental surgery.

### SUMMARY OF THE INVENTION

In some embodiments, the present invention provides a method for using a dental surgical stent comprising placing the stent body over at least one or more dentures; cutting soft tissue along an incision line; flapping the soft tissue, while being placed against the inside of the stent flap portion, outwardly away from the gum region of the patient; removing infection below the soft tissue; and reattaching the flap of the soft tissue by moving the stent flap portion to a position aligned with the stent body.

Embodiments of the present invention further provide a hard tissue stent comprising a stent body configured to drape over at least one tooth, the stent body including side members, wherein at least one of the side members extends downwards to cover at least a portion of the gum region of at least one tooth; an access opening formed in the side member of the stent body, the access opening positioned in a location for drilling hard tissue there between.

Embodiments of the present invention also provide a soft tissue stent comprising a stent body configured to drape over at least one tooth, the stent body including side members, wherein at least one of the side members extends downwards to cover at least a portion of the gum region of at least one tooth; and an incision line formed in the side member of the stent body; wherein the incision line is formed as two arc spanning about 90 degrees; the incision line is positioned adjacent to the gum region, when the stent body is disposed over at least one patient's tooth.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a sleeve for placement in a surgical guide;

FIG. 2A illustrates a left side view of a stent part similar to a nut, including two sharp parts that, after screwing in the sleeve, lifts and keeps the gingiva;

FIG. 2B illustrates a perspective view of a stent part similar to a nut, including two sharp parts that, after screwing in the sleeve, lifts and keeps the gingiva;

FIG. 3 illustrates a screw that can be attached to the sleeve when using a round bur for endo-surgical purposes;

FIG. 4A illustrates a top view of the assembled stent for round bur application;

FIG. 4B illustrates a bottom view of the assembled stent for round bur application;

FIG. 5 illustrates the assembled stent for a trephine bur application for cutting the apex;

FIG. 6 illustrates the assembled stent for a round bur application, flap lines and a finishing step;

FIG. 7 illustrates a schematic view of a stent attached on teeth;

FIG. 8 illustrates a schematic view of a stent attached on teeth; and

FIG. 9 illustrates a schematic view of a stent attached on teeth having an access opening formed therein.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any device, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a dental surgical stent that can be used to assist a dental surgeon. A hard tissue stent can include an access hole formed in one side and may be placed over one or more of the patient's teeth where the access hole is accurately aligned at a location for drilling to, for example, remove infection. A soft tissue stent may be placed over one or more of the patient's teeth, where the stent can include a mark positioned where the surgeon is to cut to create an access flap in the soft tissue. By keeping the flap attached to the semi-circular window of the soft tissue stent, the surgeon can more easily return the flap to the proper position.

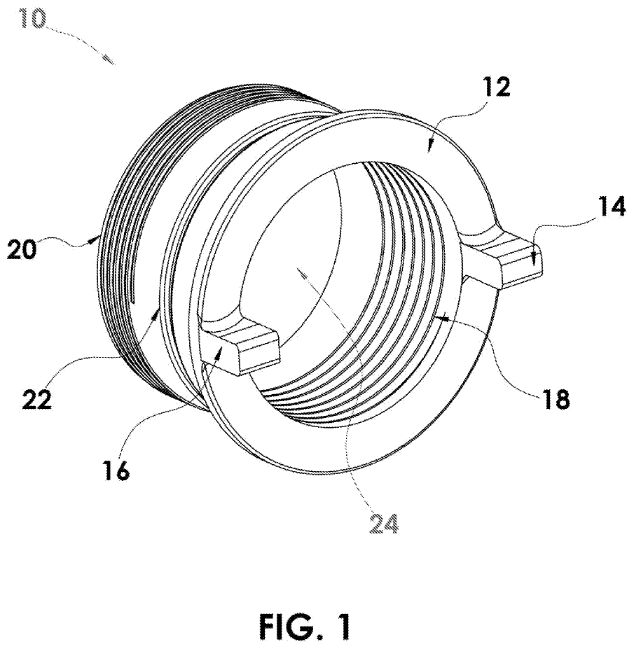

Referring now to FIGS. 1 through 4B, a sleeve 10 can include a front face 12 having one or more handles 14, 16 extending therefrom. The handles 14, 16 may extend away from the front face 12, as shown, to aid a user in rotating the sleeve 10 and the nut 30 to cause opening of the flap on the soft tissue of a patient, as discussed below.

The sleeve 10 can include inside threads 18 (also referred to as female threads 18) that begin at the front face 12 and extend downward toward a back face thereof. The sleeve 10 can include outside threads 20 (also referred to as male threads 20) extending from the back face of the sleeve 10 as shown in FIG. 1.

A groove 22 may be disposed about an exterior circumference of the sleeve 10 at a longitudinally central portion thereof. The groove 22 may be helpful to minimize the concentration of compressive stress during use of the surgical guide as discussed in greater detail below.

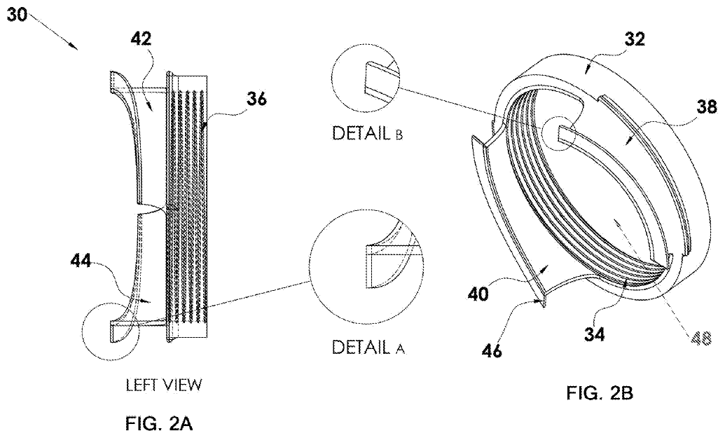

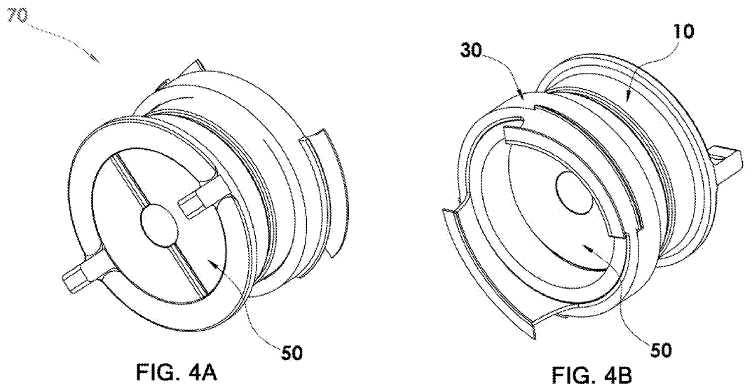

A nut 30, as shown in FIGS. 2A and 2B, can include a cylindrical exterior 32 having female threads 34 positioned on an interior of the cylindrical exterior 32. The female threads 34 can mate with the male threads 20 of the sleeve 10 when the front end 36 of the nut 30 is threaded onto the sleeve 10, thereby attaching the nut 30 to the sleeve 10 as shown in FIGS. 4A and 4B. A first side extension, having an inner surface 40 and an outer surface 44 may extend from the cylindrical exterior 32, typically along from about 35 to 55 degrees of the back end of the cylindrical exterior 32. A second side extension, having an inner surface 42 and an outer surface 38, may extend from the cylindrical exterior 32, typically along from about 35 to 55 degrees of the back end of the cylindrical exterior 32. The first and second side extensions may be disposed equally spaced apart from each other. Distal ends (distal relative to the cylindrical exterior 32) may be bent outward (away from a central opening 48 of the nut 30) at an angle, typically about 90 degrees. Sharp parts 46 may be disposed at distal ends of the first and second side extensions at the bent portions. In some embodiments, the first and second side extensions may be longer (extend farther away from the cylindrical exterior 32) adjacent the sharp parts 46, providing an edge to cut through soft tissue when the nut 32 is placed against the soft tissue and rotated.

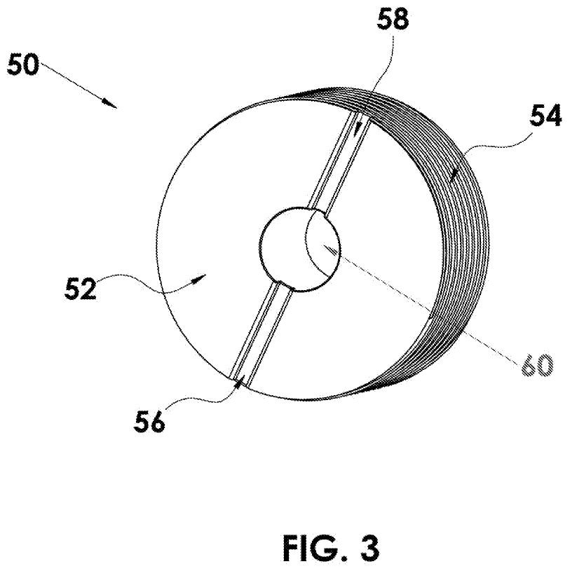

A screw 50, as shown in FIG. 3, can include an exterior thread 54 (also referred to as mail thread 54 or screw male thread 54) that extends along an entirety of the external circumference of the screw 50. The screw 50 can include a central opening 60 for use of the surgical guide, as discussed below. The screw 50 may include a front face 52 having channels 56, 58 formed therein. The channels 56, 58 can extend from the central hole 60 to the exterior of the screw 50. The channels 56, 58 may be useful for turning the screw 50 for positioning inside the sleeve 10, as discussed below. As discussed below, the screw 50 may be useful for making the opening 24 of the sleeve 10 smaller, for certain procedures, in essence reducing the opening from the size of the opening 24 to the size of the opening 60.

FIGS. 4A and 4B illustrate an assembly 70 of the screw 50, nut 30 and sleeve 10.

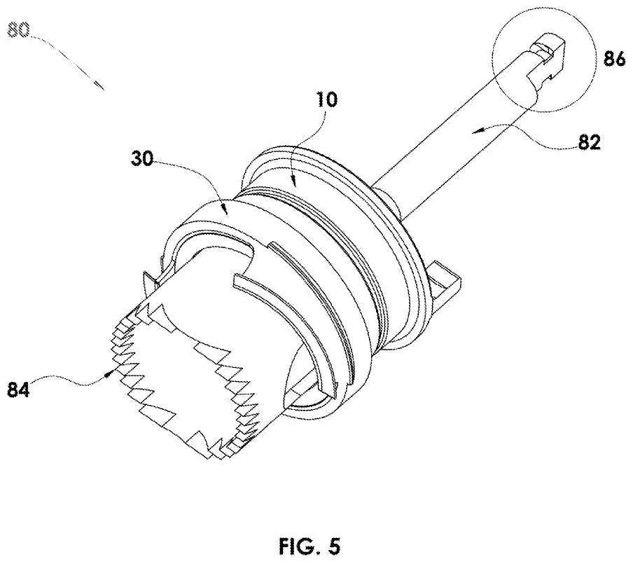

Referring now to FIG. 5, a dental assembly 80 can include the sleeve 10 assembled with the nut 30. The nut 30 may be assembled with the sleeve 10 and the sleeve 10 may be rotated, which, in turn, rotates the nut 30. The sharp parts 46 may press against soft tissue (such as the gums, or gingiva) and, as rotated, form a flap of tissue that may be lifted and kept. In the embodiment of FIG. 5, a trephine bur 84 may be attached to a shaft 82 having a dental tool attachment end 86 that provides a motive force to turn the trephine bur 84. As seen in this example, the sleeve 10 may not include the screw 50 so that the opening 24 of the sleeve 10 can receive the trephine bur 84 therethrough.

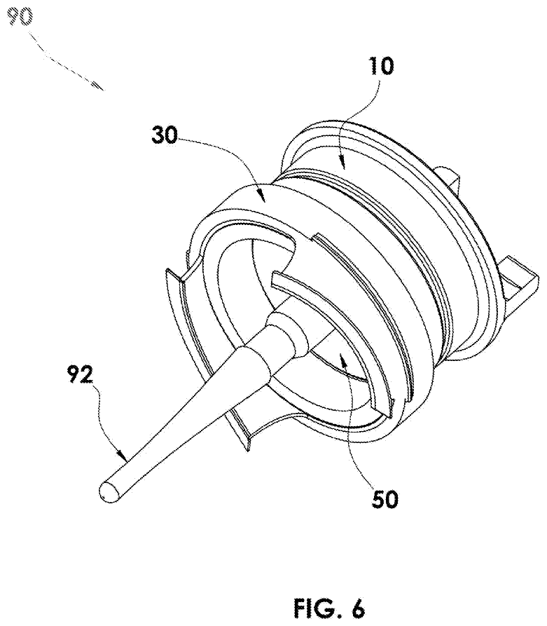

Referring now to FIG. 6, a dental assembly 80 can include the sleeve 10 assembled with the nut 30, with the screw 50 inserted in the sleeve 10. A round bur 92 may be inserted through the opening 60 of the nut 50, as shown, to provide round bur application and finishing steps.

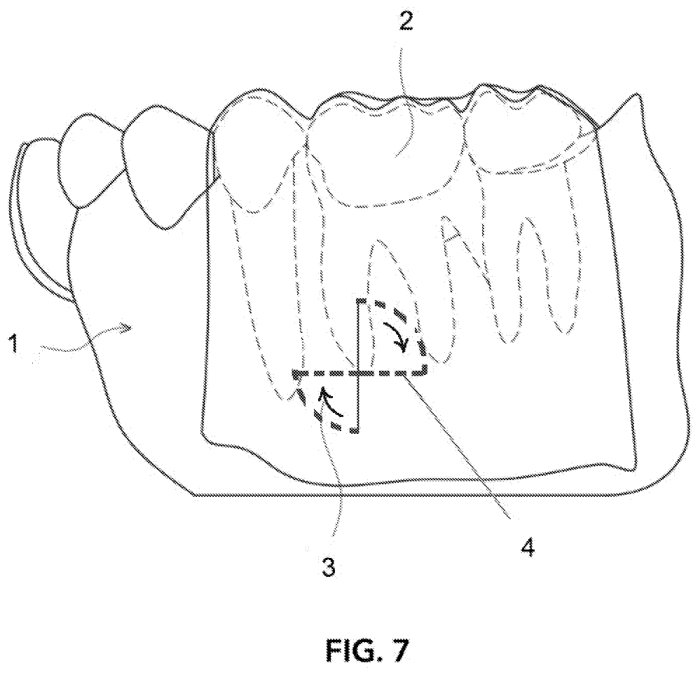

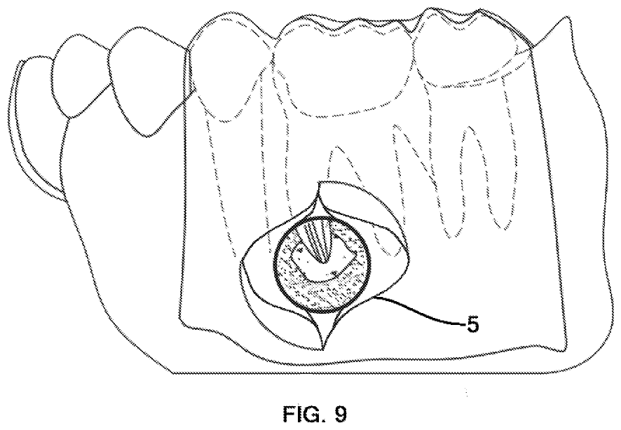

Referring to FIG. 7, a stent can be draped over at least one tooth 2, where side members of the stent body extends downward to cover at least a portion of the gum region of at least one tooth. The stent body can include an access opening 5, as shown in FIG. 9, formed in the side member to provide access positioned in a location for drilling hard tissue there between. In some embodiments, the stent body can include an incision line 4 formed in the side member of the stent body. In some embodiments, the incision line may be opened by the sharp parts 46 of the nut 30, as described above. In some embodiments, the incision line is formed as two arc spanning about 90 degrees. The incision line is positioned adjacent to the gum region when the stent body is disposed over at least one patient's tooth 2. Arrows 3 may illustrate rotation of the sharp parts 46 of the nut 30, as described above, when the assembly 70 is used with the stent of FIG. 7.

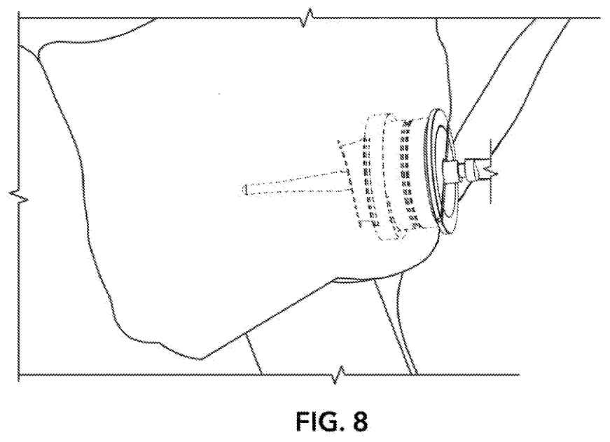

FIG. 8 illustrates the use of the assembly 70 on a patient's soft tissue, as described above.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A dental surgical stent comprising:
a stent body configured to drape over at least one tooth, the stent body including side members, where at least one of the side members extends downward to cover at least a portion of a gum region of the at least one tooth.

2. The dental surgical stent of claim 1, wherein the dental surgical stent is a hard tissue stent.

3. The dental surgical stent of claim 2, further comprising an access opening formed on the center of the stent body, the access opening positioned at a location for drilling hard tissue thereunder.

4. The dental surgical stent of claim 1, further comprising an incision line formed in a central region of the stent body.

5. The dental surgical stent of claim 4, wherein the incision line is formed as two arcs spanning about 90 degrees.

6. The dental surgical stent of claim 5, wherein the two arcs are equally spaced about a central point.

7. The dental surgical stent of claim 5, wherein the incision line is pre-cut through the stent body.

8. A method of using the dental surgical stent of claim 3, comprising:
placing the stent body of the dental surgical stent over the at least one tooth;
drilling hard tissue through the access opening.

9. A method of using the dental surgical stent of claim 4, comprising:
placing the stent body over the at least one or more teeth;
cutting soft tissue along the incision line;
flapping the soft tissue;
removing infection below the soft tissue; and
reattaching a flap of the soft tissue by moving the stent flap portion to a position aligned with the stent body.

10. The method of claim 9, wherein surgical glue is used to reattach the flap of the soft tissue.

11. The method of claim 9, wherein the flapping of the soft tissue is performed by a dental assembly including a sharp part placed against an inside surface of a stent flap portion, the sharp part attached to a nut threaded on a sleeve, the nut and sleeve assembled to permit simultaneous rotation thereof

12. A dental surgical tool comprising:
a sleeve;
sleeve female threads formed inside the sleeve, the sleeve female threads extending from a first end of the sleeve toward a central region thereof;
sleeve male threads formed on an exterior surface of the sleeve, the sleeve male threads extending from a second end of the sleeve, opposite the first end, toward the central region thereof;
a nut;
nut female threads formed inside a cylindrical portion of the nut, the nut female threads mating with the sleeve male threads;
at least two side portions extending outward from the cylindrical portion;
a bend in the side portions at a distal end thereof; and
sharp edges formed at least in the bend at ends thereof.

13. The dental surgical tool of claim 12, wherein the side portions of the nut are generally parallel to the surface of the cylindrical portion of the nut

14. The dental surgical tool of claim 12, wherein the at least two side portions include two side portions equally spaced apart from each other and spanning about 90 degrees of the exterior circumference of the cylindrical portion of the nut.

15. The dental surgical tool of claim 12, wherein a length of the side portions is configured to cause the bend to be farther away from the cylindrical portion of the nut at the sharp edged thereof.

16. The dental surgical tool of claim 12, further comprising handles extending from the first end of the sleeve.

17. The dental surgical tool of claim 12, further comprising a screw, the screw having screw male threads mating with the sleeve female threads.

18. The dental surgical tool of claim 17, wherein the screw has a central opening smaller than a central opening of the sleeve.

19. A soft tissue stent comprising:
a stent body configured to drape over at least one tooth, the stent body including side members, where at least one of the side members extends downward to cover at least a portion of a gum region of the at least one tooth; and
an incision line formed in the side member of the stent body, wherein
the incision line is formed as two arc spanning about 90 degrees; and
the incision line is positioned adjacent the gum region when the stent body is disposed over the at least one tooth of a patient.

20. The soft tissue stent of claim 19, wherein the incision line is pre-cut through the stent body.
